(19) United States
(12) Patent Application Publication
(10) Pub. No.: US 2010/0284493 A1
(43) Pub. Date: Nov. 11, 2010

(54) DOWN-SAMPLED IMPULSE RESPONSE CHANNEL ESTIMATION

(75) Inventors: Calogero Bona, Turin (IT); Ahmet Bastug, Cekmekoy/Istanbul (TR); Andrea Ancora, Nice (FR)

Correspondence Address: HOGAN LOVELLS US LLP, ONE TABOR CENTER, SUITE 1500, 1200 SEVENTEENTH ST, DENVER, CO, 80202, US

(73) Assignee: ST-ERICSSON SA, Geneva (CH)

(21) Appl. No.: 12/596,364

(22) PCT Filed: Apr. 15, 2008
(86) PCT No.: PCT/IB2008/051437

§ 371 Date: Jul. 15, 2010

(30) Foreign Application Priority Data
Apr. 16, 2007 (GB) 0707355.4
Dec. 22, 2007 (GB) 0725147.3

(51) Int. Cl. H04L 27/00

(52) U.S. Cl. 375/316

(57) ABSTRACT

A method for deriving a channel transfer function from an Orthogonal Frequency-Division Multiplex (OFDM) signal received over a channel and having unmodulated sub-carriers and sub-carriers modulated with symbols, includes the steps of sampling the received OFDM signal at a sampling rate greater than the bandwidth of the OFDM signal, deriving from the sampled OFDM signal a set of time domain coefficients representative of the channel impulse response, and deriving from a subset of the set of time domain coefficients a channel transfer function in the frequency domain.

### TECHNICAL FIELD

The invention relates to a method of estimating a channel transfer function from an orthogonal frequency division multiplex (OFDM) signal received over a channel, and to apparatus and computer program code adapted to perform the method, and to a computer readable medium comprising the computer program code.

### BACKGROUND ART

Orthogonal Frequency Division Multiple Access (OFDMA), which uses an OFDM signal, has been selected by the Third Generation Partnership Project (3GPP) for Long Term Evolution (LTE) of the Universal Mobile Telecommunications System (UMTS) mobile communication service. OFDMA can provide a good spectral efficiency and can provide band scalability, for example from 1.25 MHz to 20 MHz, in particular for the downlink, where the absence of different transmitters to synchronize (as only one base station (BS) exists) preserves the orthogonality property of the modulation scheme. The LTE transmission frame structure does not contain any OFDM preamble symbols but contains some pilot symbols embedded in the data symbols in the frequency domain for channel estimation purposes. A method of channel estimation suitable for use with such a scheme is required.

### DISCLOSURE OF INVENTION

According to a first aspect of the invention there is provided a method of estimating a channel transfer function from an OFDM signal received over a channel, the OFDM signal having unmodulated sub-carriers and sub-carriers modulated with symbols, the method comprising:

a) sampling the received OFDM signal at a sampling rate greater than the bandwith of the OFDM signal;

b) deriving from the sampled OFDM signal a set of time domain coefficients representative of the channel impulse response; and

c) deriving from a subset of the set of time domain coefficients a channel transfer function in the frequency domain.

Thus the invention involves estimating a channel transfer function by using only a subset of time domain samples of a received OFDM signal. The invention enables reduced complexity, compared with known channel estimation schemes. It can be used with either least squares (LS) estimation or linear minimum mean-squared error (LMMSE) estimation.

LS estimation usually requires the inversion of a diagonal matrix (Z in equation 9 of the description below) containing L eigenvalues, where L is the channel length, in which some of the eigenvalues are close to zero. The inversion of such eigenvalues close to zero results in unbounded values, referred to as ill conditioning. The invention overcomes the ill conditioning experienced with conventional LS estimation.

In an OFDM symbol containing N sub-carriers, only a sub-set of the sub-carriers is usually modulated (with data or pilot information), the sub-carriers on the edges of the frequency band occupied by the symbol being left unmodulated. However, the sampling frequency in the receiver is conventionally high enough to recover the signal in the whole frequency band. The invention uses a lower sampling frequency, dependent on the frequency band occupied by only the modulated sub-carriers. The lower sampling frequency may be implemented by setting to zero a proportion of the samples in an finite impulse response (FIR) representation of the channel in the time domain. In the following description the invention is referred to as a “downsampled” solution, and in particular step c) of method according to the first aspect of the invention may be regarded as downsampling.

According to a further aspect of the present invention, there is provided apparatus, such as a receiver, for carrying out the method according to the first aspect of the invention. According to a further aspect of the present invention, there is therefore provided computer software or computer program code adapted for carrying out the method according to the first aspect of the invention when processed by a processing means. The computer software or computer program code can be carried by a computer readable medium. The invention also extends to a processor running the software or code, e.g. a computer configured to carry out the method according to the first aspect of the invention.

Optionally, the modulated sub-carriers may comprise pilot symbols which are predetermined and data symbols which are arbitrary, and the set of time domain coefficients may be derived from the pilot symbols. This enables reduced complexity and higher reliability because the pilot symbols have known values and can be detected simply.

The subset of time domain coefficients as a proportion of the set of time domain coefficients may be greater than the proportion of modulated sub-carriers among the sub-carriers. In this way complexity may be reduced while retaining sufficient coefficients to estimate the channel transfer function. Optionally the subset of time domain coefficients as a proportion of the set of time domain coefficients is two thirds.

Optionally, the time domain coefficients of the subset may be selected at equal time intervals from the set of coefficients. This enables reduced complexity. Alternatively, the time domain coefficients of the subset may be selected at non-equal time intervals from the set of coefficients. This enables any desired downsampling ratio to be achieved, which can ensure simple matrix inversion.

### BRIEF DESCRIPTION OF DRAWINGS

The invention will be described, by way of example only, with reference to the accompanying drawings wherein:

FIG. 1 is a block schematic diagram of an OFDM system;

FIG. 2 is a diagram illustrating the LTE sub-frame structure;

FIG. 3 shows graphs of the real part of the estimated channel transfer functions applying the downsampling solution at a signal-to-noise ratio SNR=25 dB;

FIG. 4 is a graph of normalized mean-squared error (MSE) of the carrier-to-interference ratio (CIR) estimate; and

FIG. 5 is a table of parameters for an OFDM transmission scheme.

### DETAILED DESCRIPTION OF INVENTION

By way of example, we describe the channel estimation scheme with reference to the Long Term Evolution (LTE) of the Universal Mobile Telecommunications System (UMTS). By using the “downsampled” approach of the invention, the ill conditioning of the LS channel estimation is avoided, which occurs as a specific problem in LTE due to “partial” bandwidth excitation, namely due to pilot availability on only a subset of the subcarriers. The invention at the same time decreases the complexity. The LMMSE solution, on the other hand, does not have the ill-conditioning problem but it is again advantageous to consider downsampling in order to decrease the complexity without sacrificing performance.

The discrete-time OFDM system model is illustrated in FIG. 1. The N complex constellation symbols aᵢ are modulated on the N orthogonal sub-carriers spaced out by Δf_{c} (15 KHz) by means of the Inverse Discrete Fourier Transform (IDFT) block resulting in an N length time domain representation of the transmitted OFDM symbol.

In order to avoid Inter Block Interference (IBI) the last CP transmitted symbols are copied and appended as preamble exploiting the circular property of the Discrete Fourier Transform (DFT). The length CP of such a cyclic prefix is assumed to be longer than the channel length. A typical duration for the cyclic prefix is 4.7 μs or 16.7 μs. By way of example, in the following description only the short one is considered. However the invention is applicable to cyclic prefixes of other durations.

The obtained symbol is serialized leading to the s(k) sequence and transmitted over the discrete time channel with a sampling rate T_{S} equal to the inverse of the sampling frequency NΔf_{c}.

At the receiver side the r(k) sequence which is the sum of the transmitted signal passed through the channel and the complex circular additive white Gaussian noise w(k) with distribution N_{C}(0, σ_{w}²) is detected. Then the cyclic prefix, which is influenced by the symbols transmitted earlier through the channel, is discarded and the remaining N samples are passed through the DFT block to retrieve the complex constellation symbols transmitted over the parallel sub-channels.

In fact the available transmission bandwidth is not entirely used. A guard interval on the edges is left unmodulated in order to avoid interference between adjacent channels. Then only Nₘ, of N sub-carriers are modulated. The remaining ones are called Virtual Carriers.

Furthermore, the transmission bandwidth of the OFDM system is trivially scalable, increasing the size of the IDFT/DFT blocks and keeping the sub-carrier space constant. In the table of FIG. 5, the transmission scheme parameters of the LTE system are shown. Changing the DFT size from 128 to 2048, the band-width is scaled from 1.25 MHz to 20 MHz.

The received signal in the time domain can be represented in a matrix form as follows:

r=F^{H}AF_{L}h+w (1)

where
h is the L×1 vector corresponding to the finite impulse response (FIR) representation of the channel in the time domain
F_{L} is the N×L Fourier matrix that gives the frequency domain representation over N sub-carriers of the channel of length L
A is the diagonal matrix N×N containing on the positions corresponding to the modulated sub-carriers (Nₘ over N) the transmitted symbols (data and pilots) in the frequency domain
F^{H} is the N×N inverse Fourier matrix that gives the time domain representation of the received signal
w is the N×1 vector corresponding to the complex circular additive white Gaussian noise with N_{C}(0,σ_{w}² I_{N})

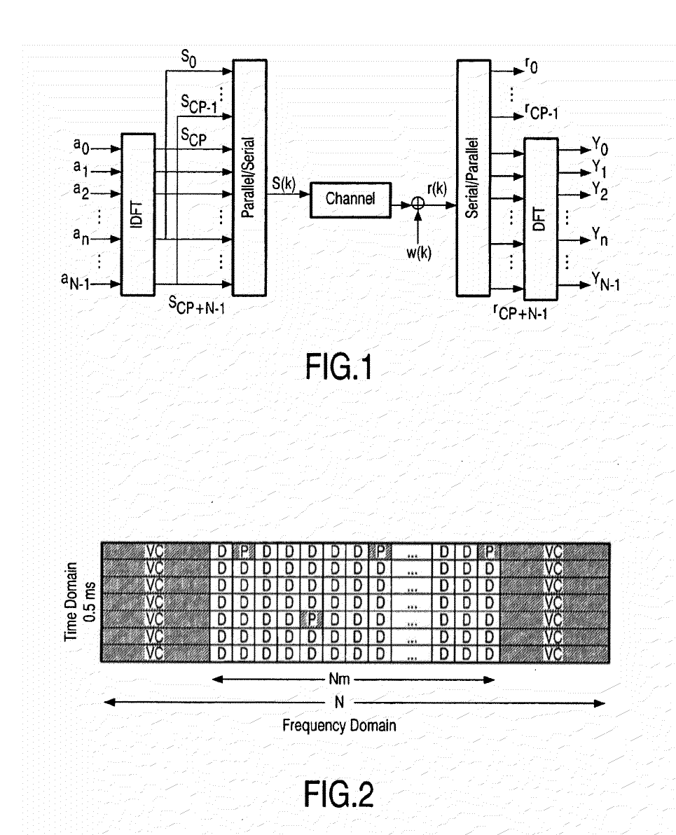

As is shown in FIG. 2, an LTE sub-frame is composed of 7 OFDM symbols and according to the table of FIG. 5, for each OFDM symbol, only Nm−1 sub-carriers over N are modulated (the sub-carrier corresponding to DC of the baseband signal is not modulated) and the remaining sub-carriers on the edges are left unmodulated.

The two pilots sequences embedded in the LTE frame are interleaved with the data samples of the first and the fifth symbols. These pilots, uniformly spaced out by 5 samples, are intended for channel estimation.

From (1) the received signal in the time domain can be written as:

r=Sh+w (2)

where

S=F^{H}AF_{L} (3)

and the diagonal matrix A containing the complex symbols modulated over the sub-channels can be expressed as:

A=A_{d}+Aₚ (4)

where A_{d} and Aₚ are again two N×N diagonal matrices containing on the corresponding elements of the diagonal the transmitted data and the transmitted pilot symbols respectively. w is the N×1 vector representing the circular complex additive white Gaussian noise with distribution N_{C}(0, σ_{w}²I_{N}).

The FIR representation h of the channel can be modelled as an L×1 random vector with circular complex Gaussian distribution N_{C}(0,Rₕ) where Rₕ is the channel covariance matrix. In particular if the channel paths are uncorrelated, Rₕ is a diagonal matrix containing the energies of channel taps.

In the following description the LS and the LMMSE criteria will be applied to estimate the channel h in the time domain. In particular the obtained LS channel estimate is:

ĥ=(S^{H}S)⁻¹S^{H}r (5)

### and the LMMSE one is

ĥ=(σ_{w}²I_{L}+RₕS^{H}S)⁻¹S^{H}r (6)

Since the transmitted data are unknown, only the pilot symbols in the matrix S are taken into account. Therefore

S=F^{H}A_{P}F_{L} (7)

### LS Estimator

Substituting (7) in (5) a simplified formulation of the LS estimator is obtained (where the unitary property of the matrix F^{H} is used):

ĥ=(F_{L}^{H}Aₚ^{H}AₚF_{L})⁻¹F_{L}^{H}Aₚ^{H}Fr (8)

A serious problem that is encountered in the straight application of the LS estimator is that the inversion of the L×L matrix turns out to be ill conditioned and hence it cannot be done properly.

The invention provides a solution to this problem. Considering, for example, the case in the table of FIG. 5 in which the symbol size N is equal to 1024 and the number of modulated sub-carriers is only 600. Hence, while the sampling frequency is 15.36 MHz (N×Δf_{c}), the occupied band width is only 9 MHz (Nₘ×Δf_{c}). It follows that, in practice we are trying to estimate the channel in the whole 15.36 MHz bandwidth while we are exciting only the modulated sub-carriers (9 MHz). The channel can indeed be sounded only in the excited band. In order to do this, we should increase the “numerical bandwidth”, which is considered to be the ratio between the occupied bandwidth and the sampling frequency, to a value slightly smaller than 1. This can be done by decreasing the sampling frequency used for the numerical representation of the channel by a factor 2/3, which ensures the absence of aliasing giving a resulting sampling frequency of 10.24 MHz.

What we do in practice is to estimate the channel h not in all the L taps but only in, for example, 2 out of 3 taps, so obtaining the average downsampling factor 2/3, and setting the discarded ones to 0. In fact the channel “equalization” in the OFDM system is not performed in the time domain but in the frequency domain. Therefore it is not necessary to have an exact time domain representation of the channel at the actual sampling frequency. What is important is only the channel transfer function in the band of interest.

Equation (11) is an expression for the channel transfer function H without using the downsampling, and equation (12) is the corresponding expression for the channel transfer function H^{DS} after downsampling.

$$\begin{matrix}\begin{matrix} H & {F}_{L} & h\end{matrix} \\ ( \begin{matrix}{H}_{0} \\ {H}_{1} \\ {H}_{2} \\ {H}_{3} \\ {H}_{4} \\ {H}_{5} \\ ⋮ \\ {H}_{N - 1}\end{matrix} ) = ( \begin{matrix}1 & 1 & 1 & 1 & ⋯ & 1 \\ 1 & {w}^{1 \cdot 1} & {w}^{1 \cdot 2} & {w}^{1 \cdot 3} & ⋯ & {w}^{1 \cdot ( L - 1 )} \\ 1 & {w}^{2 \cdot 1} & {w}^{2 \cdot 2} & {w}^{2 \cdot 3} & ⋯ & {w}^{2 \cdot ( L - 1 )} \\ 1 & {w}^{3 \cdot 1} & {w}^{3 \cdot 2} & {w}^{3 \cdot 3} & ⋯ & {w}^{3 \cdot ( L - 1 )} \\ 1 & {w}^{4 \cdot 1} & {w}^{4 \cdot 2} & {w}^{4 \cdot 3} & ⋯ & {w}^{4 \cdot ( L - 1 )} \\ 1 & {w}^{5 \cdot 1} & {w}^{5 \cdot 2} & {w}^{5 \cdot 3} & ⋯ & {w}^{5 \cdot ( L - 1 )} \\ ⋮ & ⋮ & ⋮ & ⋮ & ⋮ & ⋮ \\ 1 & {w}^{( N - 1 ) \cdot 1} & {w}^{( N - 1 ) \cdot 2} & {w}^{( N - 1 ) \cdot 3} & ⋯ & {w}^{( N - 1 ) \cdot ( L - 1 )}\end{matrix} ) ( \begin{matrix}{h}_{0} \\ {h}_{1} \\ 0 \\ {h}_{3} \\ {h}_{4} \\ 0 \\ ⋮ \\ {h}_{L - 1}\end{matrix} ) \\ \begin{matrix} N \times 1 & N \times L & L \times 1\end{matrix} & ( 11 ) \\ \begin{matrix} {H}^{DS} & {F}_{L}^{DS} & {h}^{DS}\end{matrix} \\ ( \begin{matrix}{H}_{0} \\ {H}_{1} \\ {H}_{2} \\ {H}_{3} \\ {H}_{4} \\ {H}_{5} \\ ⋮ \\ {H}_{N - 1}\end{matrix} ) = ( \begin{matrix}1 & 1 & 1 & ⋯ & 1 \\ 1 & {w}^{1 \cdot 1} & {w}^{1 \cdot 3} & ⋯ & {w}^{1 \cdot ( L - 1 )} \\ 1 & {w}^{2 \cdot 1} & {w}^{2 \cdot 3} & ⋯ & {w}^{2 \cdot ( L - 1 )} \\ 1 & {w}^{3 \cdot 1} & {w}^{3 \cdot 3} & ⋯ & {w}^{3 \cdot ( L - 1 )} \\ 1 & {w}^{4 \cdot 1} & {w}^{4 \cdot 3} & ⋯ & {w}^{4 \cdot ( L - 1 )} \\ 1 & {w}^{5 \cdot 1} & {w}^{5 \cdot 3} & ⋯ & {w}^{5 \cdot ( L - 1 )} \\ ⋮ & ⋮ & ⋮ & ⋮ & ⋮ \\ 1 & {w}^{( N - 1 ) \cdot 1} & {w}^{( N - 1 ) \cdot 3} & ⋯ & {w}^{( N - 1 ) \cdot ( L - 1 )}\end{matrix} ) ( \begin{matrix}{h}_{0} \\ {h}_{1} \\ {h}_{3} \\ {h}_{4} \\ ⋮ \\ {h}_{L - 1}\end{matrix} ) \\ \begin{matrix} N \times 1 & N \times \frac{2}{3} L & \frac{2}{3} L \times 1\end{matrix} & ( 12 ) \\ w = {e}^{j \frac{2 π}{N}} & ( 13 )\end{matrix}$$

As is shown by (11) and (12), using this approach it turns out that in the received signal representation (1), the L/3 columns of the Fourier matrix F_{L} corresponding to the neglected taps are multiplied by 0, so the time domain received signal can be represented as:

r=F^{H}AF_{L}^{DS}h^{DS}+w (14)

where h^{DS} is the downsampled version of the FIR channel representation with the resulting vector length 2/3L. Analogously F_{L}^{DS} is equal to the Fourier matrix F_{L} where the columns corresponding to the removed taps of h are removed.

In the following description, in order to avoid complicating the notation, the downsampled channel and the corresponding Fourier matrix will be indicated by h and F_{L}.

Using the Fourier matrix corresponding to the downsampled channel the ill conditioning problem is resolved and furthermore a complexity gain of 33% is obtained because now the size of the matrix (F_{L}^{H}Aₚ^{H}AₚF_{L})⁻¹F_{L}^{H} turns out to be 2/3L×N.

If the pilots are modulated by a constant modulus modulation, the diagonal matrix Aₚ^{H}Aₚ does not depend on the specific transmitted pilot sequence but only on the positions of the pilots which are constant and defined by the sub-frame structure. Furthermore, in this case, the channel h is considered as a deterministic vector, so no a priori knowledge on its statistics is needed. It follows that the matrix (F_{L}^{H}Aₚ^{H}AₚF_{L})⁻¹F_{L}^{H} is constant, hence the matrix inversion can be computed “off-line” and used for every channel estimation regardless of the varying channel statistics. This is another very important advantage of “downsampled” LS scheme.

### LMMSE Estimation

As has already been done for the LS estimator, substituting the (7) in (6) the expression of the LMMSE channel estimate is obtained:

ĥ=(σ_{w}²I_{L}+RₕF_{L}^{H}Aₚ^{H}AₚF_{L})⁻¹RₕF_{L}^{H}Aₚ^{H}Fr (15)

Also in this case, considering a constant modulus modulation of the pilots, the diagonal matrix Aₚ^{H}Aₚ is constant regardless of the specific transmitted pilot sequence. But now, in order to apply a model based implementation of this estimator, the noise covariance σ_{w}² and the channel covariance matrix Rₕ must be estimated each time, requiring a higher computational cost.

The ill conditioning problem encountered in the LS estimator is not present in the LMMSE one because the noise covariance matrix is a diagonal matrix which works like the regularization term a used in the first solution. Nevertheless the downsampled solution is still highly preferable for the LMMSE estimator in order to benefit from the complexity reduction without sacrificing from performance.

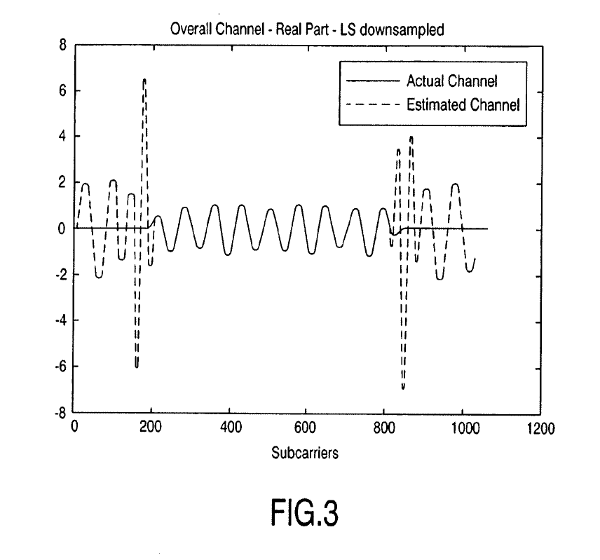

Simulations of the proposed scheme have been performed. In FIG. 3 the real part of the transfer function of the LS estimated channel using the downsampled solution is shown (the results for the imaginary parts are similar and hence are omitted). In these simulations a sinc pulse shape limiting the band of the resulting overall channel to the 9 MHz of the modulated subcarriers was used. It can be seen that the method gives a proper estimation over the band of interest (the 600 central sub-carriers).

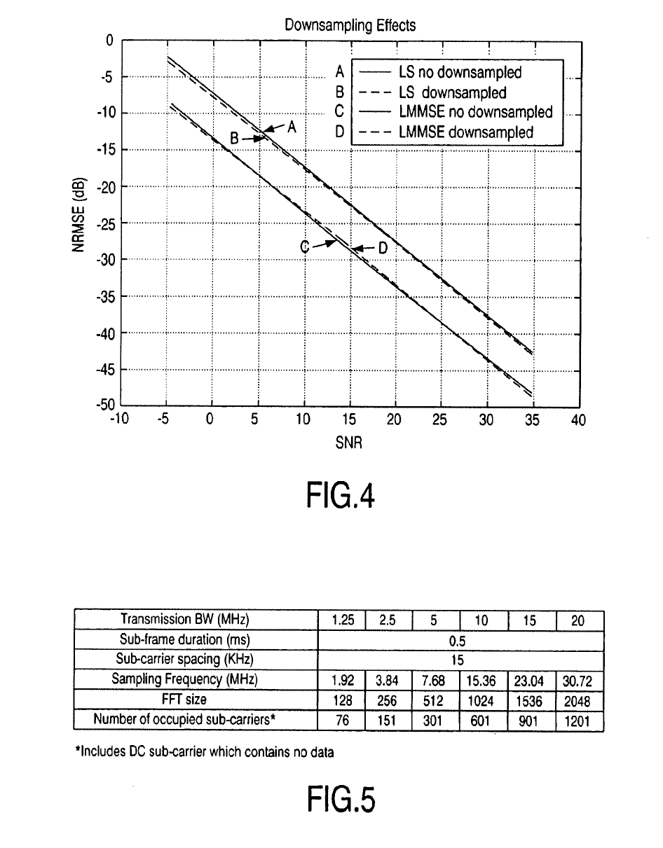

FIG. 4 shows the performances of the LMMSE and the LS estimator plotting the MSE normalized with respect to the energy of the channel. In both cases the traditional formulations are compared with the downsampled solutions highlighting the performance equivalence of the methods. The curves were obtained by means of Monte Carlo simulations and in the LMMSE criterion a perfect knowledge of the channel correlation matrix was assumed.

Since the LMMSE estimator exploits the a priori information about the channel and the noise its performances are 7 dB better than the LS ones but would involve a much greater computational cost in estimating the statistics and inverting the matrix σ_{w}²I_{L}+RₕF_{L}^{H}Aₚ^{H}AₚF_{L}.

On the other hand the LS method is computationally simpler to apply, it does not need any a priori information and does not need to invert any matrix on-line and even if the performance is lower than the LMMSE method that are still acceptable.

Although embodiments have been described for an OFDM signal in which the modulated sub-carriers are modulated with data symbols and pilot symbols, and in which the set of time domain coefficients representative of the channel impulse response are derived from the pilots symbols, the invention is also applicable when the OFDM signal comprises data symbols without pilot symbols, and when the set of time domain coefficients representative of the channel impulse response are derived from the data symbols.

In general, the subset of time domain coefficients as a proportion of the set may be equal to or greater than the proportion of modulated sub-carriers among the sub-carriers.

The time domain coefficients of the subset may be selected at equal or non-equal time intervals from the set of coefficients.

The invention extends to apparatus, such as a receiver, for carrying out the method of the invention. This might comprise a processor, digital signal processor (DSP), central processing unit (CPU) or such like. Additionally or alternatively, it might comprise a hard-wired circuit or circuits, such as an application-specific integrated circuit (ASIC), or by embedded software. It can also be appreciated that the invention can be implemented using computer program code. Accordingly the invention extends to computer software or computer program code adapted to carry out the invention described herein when processed by a processing means. The computer software or computer program code can be carried by a computer readable medium. The medium may be a physical storage medium such as a Read Only Memory (ROM) chip. Alternatively, it may be a disk such as a Digital Versatile Disk (DVD-ROM) or Compact Disk (CD-ROM). It could also be a signal such as an electronic signal over wires, an optical signal or a radio signal such as to a satellite or the like. The invention also extends to a processor running the software or code, e.g. a computer configured to carry out the method described above.

From reading the present disclosure, other variations and modifications will be apparent to the skilled person. Such variations and modifications may involve equivalent and other features which are already known in the art of signal processing and communications, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality.

1. A method of deriving a channel transfer function from an OFDM signal received over a channel, the OFDM signal having unmodulated sub-carriers and sub-carriers modulated with symbols, the method comprising:
a) sampling the received OFDM signal at a sampling rate greater than or equal to the bandwidth of the OFDM signal;
b) deriving from the sampled OFDM signal a set of time domain coefficients representative of the channel impulse response; and
c) deriving from a subset of the set of time domain coefficients a channel transfer function in the frequency domain.

2. A method as claimed in claim 1, wherein the modulated sub-carriers comprise pilot symbols which are predetermined and data symbols which are arbitrary, comprising deriving the set of time domain coefficients from the pilot symbols.

3. A method as claimed in claim 1, wherein the subset as a proportion of the set is greater than the proportion of modulated sub-carriers among the sub-carriers.

4. A method as claimed in claim 3, wherein the subset as a proportion of the set is two thirds.

5. A method as claimed in claim 1, wherein the time domain coefficients of the subset are selected at equal time intervals from the set of coefficients.

6. A method as claimed in claim 1, wherein the time domain coefficients of the subset are selected at non-equal time intervals from the set of coefficients.

7. A method as claimed in claim 2, comprising in step b) deriving the set of time domain coefficients representative of the channel impulse response as
h=(F_{L}^{H}Aₚ^{H}AₚF_{L})⁻¹F_{L}^{H}Aₚ^{H}Fr, where
h is a vector of dimension L×1 comprising the set of time domain coefficients, and L is the number of samples of the received OFDM signal,
r is a vector of dimension L×1 comprising the L samples of the received OFDM signal,
F is a Fourier transform matrix of dimension N×N, where N is the number sub-carriers in the plurality of sub-carriers,
F_{L} is a Fourier transform matrix of dimension an N×L for transforming L samples in the time domain into N frequency coefficients in the frequency domain,
F_{L}^{H} is an inverse Fourier matrix of dimension L×N for transforming N frequency coefficients in the frequency domain into L coefficients in the time domain,
Aₚ is a diagonal matrix of dimension N×N containing diagonal elements representative of the transmitted pilot symbols, and
Aₚ^{H} is the hermitian of a diagonal matrix containing the pilot symbols in the pilot positions and zero elsewhere.

8. A method as claimed in claim 2, comprising in step b) deriving the set of coefficients representative of the channel impulse response as
h=(σ_{w}²I_{L}+RₕF_{L}^{H}Aₚ^{H}AₚF_{L})⁻¹RₕF_{L}^{H}Aₚ^{H}Fr, where
h is a vector of dimension L×1 comprising the set of time domain coefficients, and L is the number of samples of the received OFDM signal,
r is a vector of dimension L×1 comprising the L samples of the received OFDM signal,
F is a Fourier transform matrix of dimension N×N, where N is the number sub-carriers in the plurality of sub-carriers,
F_{L} is a Fourier transform matrix of dimension N×L for transforming L samples in the time domain into N frequency coefficients in the frequency domain,
F_{L}^{H} is an inverse Fourier matrix of dimension L×N for transforming N frequency coefficients in the frequency domain into L coefficients in the time domain,
Aₚ is a diagonal matrix of dimension N×N containing diagonal elements representative of the transmitted pilot symbols,
Aₚ^{H} is the hermitian of a diagonal matrix containing the pilot symbols in the pilot positions and zero elsewhere,
Rₕ is the covariance matrix of h,
σ_{w}²I_{L} is the covariance matrix of the estimated noise power.

9. A method as claimed in claim 7, comprising deriving the channel transfer function in step c) as F_{L}^{DS}×h^{DS}, where h^{DS} is a vector of dimension L^{DS}×1 comprising the subset of time domain coefficients of h, L^{DS} is the number of samples of the subset, and F_{L}^{DS} is a matrix of dimension N×L^{DS} comprising only the columns of F_{L} which correspond to the subset of the time domain coefficients of h.

10. Apparatus adapted to perform the method of claim 1.

11. Computer program code adapted to perform the method of claim 1.

12. A computer readable medium comprising computer program code adapted to perform the method of claim 1.

13. A method as claimed in claim 2, wherein the subset as a proportion of the set is greater than the proportion of modulated sub-carriers among the sub-carriers.

14. A method as claimed in claim 13, wherein the subset as a proportion of the set is two thirds.

15. A method as claimed in claim 2, wherein the time domain coefficients of the subset are selected at non-equal time intervals from the set of coefficients.

16. A method as claimed in claim 3, wherein the time domain coefficients of the subset are selected at non-equal time intervals from the set of coefficients.

17. A method as claimed in claim 13, wherein the time domain coefficients of the subset are selected at non-equal time intervals from the set of coefficients.

18. A method as claimed in claim 14, wherein the time domain coefficients of the subset are selected at non-equal time intervals from the set of coefficients.

19. A method as claimed in claim 8, comprising deriving the channel transfer function in step c) as F_{L}^{DS}×h^{DS}, where h^{DS} is a vector of dimension L^{DS}×1 comprising the subset of time domain coefficients of h, L^{DS} is the number of samples of the subset, and F_{L}^{DS} is a matrix of dimension N×L^{DS} comprising only the columns of F_{L} which correspond to the subset of the time domain coefficients of h.
